(19) United States
(12) Patent Application Publication
(10) Pub. No.: US 2025/0272390 A1
(43) Pub. Date: Aug. 28, 2025

(54) A Method to Prevent Exploitation of AI Module in an AI System

(71) Applicants: Robert Bosch GmbH, Stuttgart (DE); Bosch Global Software Technologies Private Limited, Bangalore (IN)

(72) Inventors: Adit Jignesh Shah, Ahmedabad (IN); Manojkumar Somabhai Parmar, Ahmedabad (IN); Tanya Motwani, Bangalore (IN); Mayurbhai Thesia Yash, Ahmedabad (IN)

(21) Appl. No.: 18/879,022

(22) PCT Filed: Jun. 29, 2023
(86) PCT No.: PCT/EP2023/067868

§ 371 Date: Dec. 26, 2024

(30) Foreign Application Priority Data
Jun. 29, 2022 (IN) 2022 4103 7261

(51) Int. Cl. G06F 21/55

(52) U.S. Cl. CPC G06F 21/554; G06F 2221/033

(57) ABSTRACT

A method prevents exploitation of an AI module in an AI system. The AI module is configured to process input data. The AI module includes an AI model and at least a comparator. The AI model includes a plurality of processing layers, at least one of the processing layers further includes one or more parallel processing sub-layers. The comparator is configured to compare a first set of outputs received from the plurality of processing layers and the parallel processing sub-layers to identify an attack vector from the input data.

### FIELD OF THE INVENTION

The present disclosure relates to the field of Artificial Intelligence security. In particular, the present disclosure proposes a method to prevent exploitation of an AI module in an AI system and the AI system thereof.

### BACKGROUND OF THE INVENTION

With the advent of data science, data processing and decision making systems are implemented using artificial intelligence modules. The artificial intelligence modules use different techniques like machine learning, neural networks, deep learning etc. Most of the AI based systems, receive large amounts of data and process the data to train AI models. Trained AI models generate output based on the use cases requested by the user. Typically the AI systems are used in the fields of computer vision, speech recognition, natural language processing, audio recognition, healthcare, autonomous driving, manufacturing, robotics etc. where they process data to generate required output based on certain rules/intelligence acquired through training.

To process the inputs and give a desired output, the AI systems use various models/algorithms which are trained using the training data. Once the AI system is trained using the training data, the AI systems use the models to analyze the real time data and generate appropriate result. The models may be fine-tuned in real-time based on the results. The models in the AI systems form the core of the system. Lots of effort, resources (tangible and intangible), and knowledge goes into developing these models.

It is possible that some adversary may try to capture/copy/extract the model from AI systems. The adversary may use different techniques to exploitation the model from the AI systems. One of the simple techniques used by the adversaries is where the adversary sends different queries to the AI system iteratively, using its own test data. The test data may be designed in a way to extract internal information about the working of the models in the AI system. The adversary uses the generated results to train its own models. By doing these steps iteratively, it is possible to exploitation the internals of the model and a parallel model can be built using similar logic. This will cause hardships to the original developer of the AI systems. The hardships may be in the form of business disadvantages, loss of confidential information, loss of lead time spent in development, loss of intellectual properties, loss of future revenues etc. Hence there is a need for an AI system that is self-sufficient in averting adversarial attacks and identifying and attack vector.

There are methods known in the prior arts to identify such attacks by the adversaries and to protect the models used in the AI system. The prior art US 20190095629A1—Protecting Cognitive Systems from Model Stealing Attacks discloses one such method. It discloses a method wherein the input data is processed by applying a trained model to the input data to generate an output vector having values for each of the plurality of pre-defined classes. A query engine modifies the output vector by inserting a query in a function associated with generating the output vector, to thereby generate a modified output vector. The modified output vector is then output. The query engine modifies one or more values to disguise the trained configuration of the trained model logic while maintaining accuracy of classification of the input data.

### BRIEF DESCRIPTION OF THE ACCOMPANYING DRAWINGS

An embodiment of the invention is described with reference to the following accompanying drawings:

FIG. 1 depicts an AI system (100);

FIG. 2 depicts an AI module (14) in the AI system (100);

FIG. 3 illustrates method steps (200) to prevent exploitation of an AI module (14) in an AI system (100).

### DETAILED DESCRIPTION OF THE DRAWINGS

It is important to understand some aspects of artificial intelligence (AI) technology and artificial intelligence (AI) based systems or artificial intelligence (AI) system. Some important aspects of the AI technology and AI systems can be explained as follows. Depending on the architecture of the implements AI systems may include many components. One such component is an AI module. An AI module with reference to this disclosure can be explained as a component which runs a model. A model can be defined as reference or an inference set of data, which is use different forms of correlation matrices. Using these models and the data from these models, correlations can be established between different types of data to arrive at some logical understanding of the data. A person skilled in the art would be aware of the different types of AI models such as linear regression, naïve bayes classifier, support vector machine, neural networks and the like. It must be understood that this disclosure is not specific to the type of model being executed in the AI module and can be applied to any AI module irrespective of the AI model being executed. A person skilled in the art will also appreciate that the AI module may be implemented as a set of software instructions, combination of software and hardware or any combination of the same.

Some of the typical tasks performed by AI systems are classification, clustering, regression etc. Majority of classification tasks depend upon labeled datasets; that is, the data sets are labelled manually in order for a neural network to learn the correlation between labels and data. This is known as supervised learning. Some of the typical applications of classifications are: face recognition, object identification, gesture recognition, voice recognition etc. Clustering or grouping is the detection of similarities in the inputs. The cluster learning techniques do not require labels to detect similarities. Learning without labels is called unsupervised learning. Unlabeled data is the majority of data in the world. One law of machine learning is: the more data an algorithm can train on, the more accurate it will be. Therefore, unsupervised learning models/algorithms has the potential to produce accurate models as training dataset size grows.

As the AI module forms the core of the AI system, the module needs to be protected against attacks. AI adversarial threats can be largely categorized into—model extraction attacks, inference attacks, evasion attacks, and data poisoning attacks. In poisoning attacks, the adversarial carefully inject crafted data to contaminate the training data which eventually affects the functionality of the AI system. Inference attacks attempt to infer the training data from the corresponding output or other information leaked by the target model. Studies have shown that it is possible to recover training data associated with arbitrary model output. Ability to extract this data further possess data privacy issues. Evasion attacks are the most prevalent kind of attack that may occur during AI system operations. In this method, the attacker works on the AI algorithm's inputs to find small perturbations leading to large modifications of its outputs (e.g., decision errors) which leads to evasion of the AI model.

In Model Extraction Attacks (MEA), the attacker gains information about the model internals through analysis of input, output, and other external information. Stealing such a model reveals the important intellectual properties of the organization and enables the attacker to craft other adversarial attacks such as evasion attacks. This attack is initiated through an attack vector. In the computing technology a vector may be defined as a method in which a malicious code/virus data uses to propagate itself such as to infect a computer, a computer system or a computer network. Similarly, an attack vector is defined a path or means by which a hacker can gain access to a computer or a network in order to deliver a payload or a malicious outcome. A model stealing attack uses a kind of attack vector that can make a digital twin/replica/copy of an AI module.

The attacker typically generates random queries of the size and shape of the input specifications and starts querying the model with these arbitrary queries. This querying produces input-output pairs for random queries and generates a secondary dataset that is inferred from the pre-trained model. The attacker then take this I/O pairs and trains the new model from scratch using this secondary dataset. This is black box model attack vector where no prior knowledge of original model is required. As the prior information regarding model is available and increasing, attacker moves towards more intelligent attacks. The attacker chooses relevant dataset at his disposal to extract model more efficiently. This is domain intelligence model-based attack vector. With these approaches, it is possible to demonstrate model stealing attack across different models and datasets.

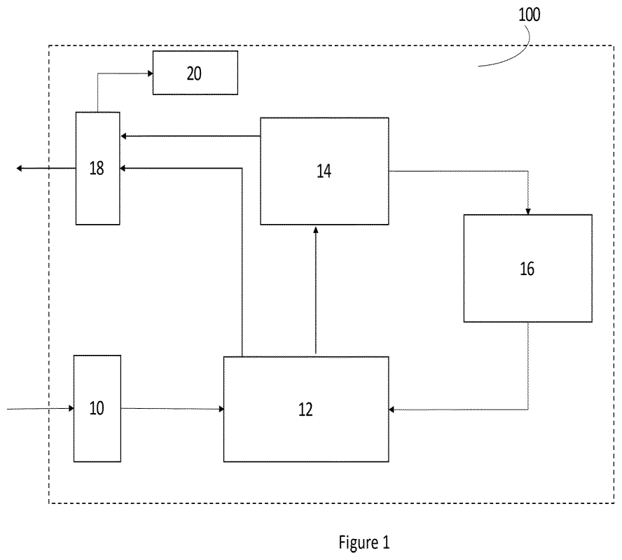

FIG. 1 depicts an AI system (100). The AI system (100) comprises an input interface (10), a blocker module (12), an AI module (14), a blocker notification module (16), an information gain module (16) and at least an output interface (18). The input interface (10) receives input data from at least one user. The input interface (10) is a hardware interface wherein a user can enter his query for the AI module (14) to process and generate a output.

A module with respect to this disclosure can either be a logic circuitry or a software programs that respond to and processes logical instructions to get a meaningful result. A module is implemented as any or a combination of: one or more microchips or integrated circuits interconnected using a parent board, hardwired logic, software stored by a memory device and executed by a microprocessor, microcontrollers, firmware, an application specific integrated circuit (ASIC), and/or a field programmable gate array (FPGA). As explained above, these various modules can either be a software embedded in a single chip or a combination of software and hardware where each module and its functionality is executed by separate independent chips connected to each other to function as the system. For example, a neural network (in an embodiment the AI module (14)) mentioned herein after can be a software residing in the system or the cloud or embodied within an electronic chip. Such neural network chips are specialized silicon chips, which incorporate AI technology and are used for machine learning.

The blocker module (12) is configured to block a user when the information gain exceeds a predefined threshold. Information gain is calculated based on input attack queries exceeds a predefined threshold value. Information gain is a quantitative analysis of the portion of AI model stolen or compromised due to the impact of an attack vector. The blocker module (12) is further configured to block a user. This is done only when the input is identified as an attack vector and the information gain exceeds a pre-determined critical threshold.

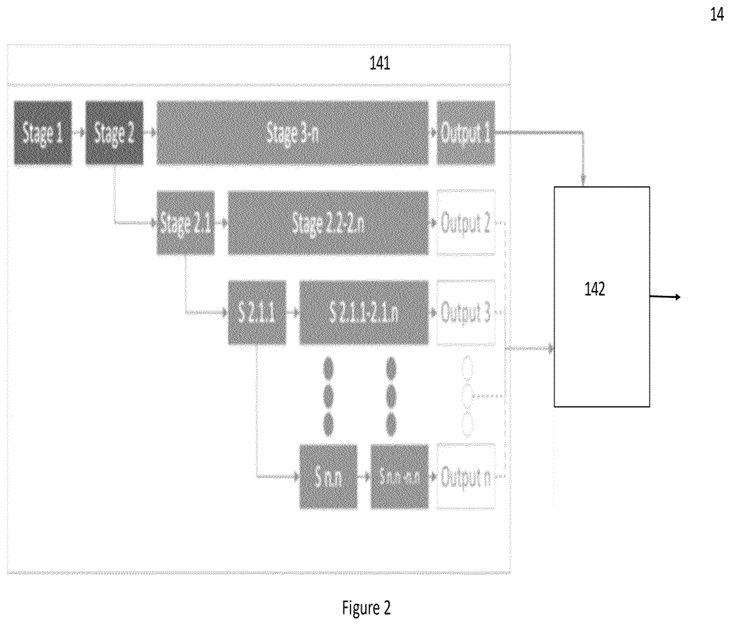

The most important non-limiting feature of the AI system (100) is the design and thereby the functionality of the AI module (14). FIG. 2 depicts structure of the AI module (14). The AI module (14) comprises an AI model (141) and at least a comparator (142). The AI module (14) executes a model (M) based on the input to generate a first set of outputs. The model could be any one from those mentioned above such as linear regression, naïve bayes classifier, support vector machine or neural networks and the like. It must be understood that this disclosure is not specific to the type of model being executed in the AI module (14) and can be applied to any AI module (14) irrespective of the AI model (141) being executed. A person skilled in the art will also appreciate that the AI model (141) may be implemented as a set of software instructions, combination of software and hardware or any combination of the same.

The AI model (141) comprises a plurality of processing layers (1, 2 . . . n), at least one of the said processing layers further comprising one or more parallel processing sub-layers (for example 2.1-2.n). A processing layer for an AI model (141) can be defined as a container that usually receives weighted input, transforms it with a set of mostly non-linear functions and then passes these values as output to the next layer.

The comparator (142) is configured to compare a first set of outputs received from the plurality of processing layers and the parallel processing sub-layers to identify the attack vector from the said input, the identification information is sent to the information gain module (16). A differing first set of outputs received from the plurality of processing layers and the parallel processing sub-layers identifies the said input as an attack vector. The comparator (142) can be a conventional electronic comparator (142) or specialized electronic comparator (142) either embedded with neural networks or executing another AI model (141) to enhance their functions. The above-mentioned components of the AI module (14) can either be implemented in a single chip or as any or a combination of: one or more microchips or integrated circuits interconnected using a parent board, hardwired logic, software stored by a memory device and executed by a microprocessor, firmware, an application specific integrated (ASIC), and/or a field programmable gate array (FPGA).

It should be understood at the outset that, although exemplary embodiments are illustrated in the figures and described below, the present disclosure should in no way be limited to the exemplary implementations and techniques illustrated in the drawings and described below.

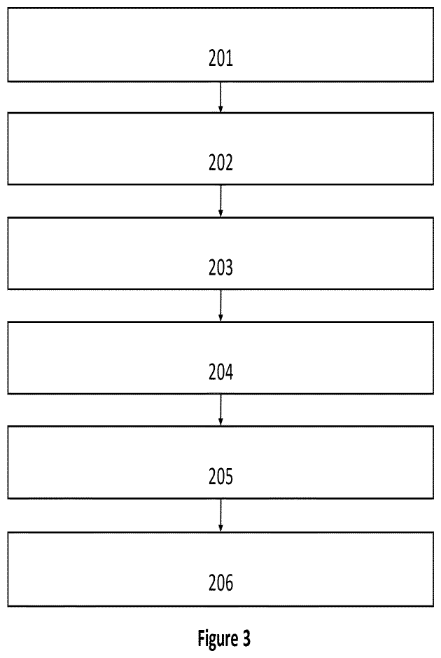

FIG. 3 illustrates method steps to prevent exploitation of an AI module (14) in an AI system (100). The components of the AI system (100) have been explained in accordance with FIG. 1 and FIG. 2. Method Step 201 comprises receiving input data from at least one user through an input interface (10). The input interface (10) is same as the one described in accordance with FIG. 1.

Method step 202 comprises transmitting input data through the blocker module (12) to the AI module (14). Method step 203 comprises processing input data by the plurality of processing layers of the AI module (14) to generate a first output. Method step 204 comprises processing the input date by the plurality of processing layers and the parallel processing sub-layers to generate a first set of output.

Method step 205 comprises comparing the generated first set of outputs by the comparator (142) to identify an attack vector from the input data, the identification information of the attack vector is sent to the information gain module (16). A differing first set of outputs received from the plurality of processing layers and the parallel processing sub-layers identifies the said input as an attack vector.

The underlying concept here is that we train a model that has multiple outputs via the plurality of processing layers and the parallel processing sub-layers. Each sub-layer is a separate network with different configuration and learns the weights differently during the training phase. The difference in weight and architecture means the decision boundaries are different. The non-robust features of the data varies for each model. When the attack vector passes through all of the outputs, then overall class value changes because of different latent boundaries. We can detect the attack vectors using this difference in output probability values. On the other hand, when any original data comes, then it gives the same class as output because of its robust features. When an attack vector passes through the different output layers, the generated outputs will be different due to varied decision boundaries. The difference in the output is an indicator of an attack vector.

Methods step 206 comprises sending an output by means of the output interface (18) to prevent capturing of an AI module (14). The comparator (142) sends the first output as the output to the output interface (18), when an attack vector is not identified. the comparator (142) modifies the first output to send the output to the output interface (18), when an attack vector is identified. The user is blocked by a blocker module (12) in dependence of information received from the information gain module (16). Post detection of the attack vector we can either send a blocking output or send out a manipulated output. The manipulated output is selected as the lowest probability value class (the class of output which is the total opposite of the original output). Hence, the attacker will receive the wrong output and will not be in a position to train models with reasonable accuracy, thereby preventing the exploitation of AI module (14).

In an alternate embodiment of the present disclosure, the attack vector identification information is sent to the information gain module (16), an information gain is calculated. The information gain is sent to the blocker module (12). If the information gain exceeds a pre-defined threshold, the user is blocked, and the notification is sent the owner of the AI system (100) using blocker notification module (16) as one of the embodiment. If the information gain is below a pre-defined threshold, although an attack vector was detected, the blocker module (12) may modify the first output generated by the AI module (14) to send it to the output interface (18).

In addition, the user profile may be used to determine whether the user is habitual attacker or was it one time attack or was it only incidental attack etc. Depending upon the user profile, the steps for unlocking of the system may be determined. If it was first time attacker, the user may be locked out temporarily. If the attacker is habitual attacker then a stricter locking steps may be suggested.

As explained above, these various modules can either be a software embedded in a single chip or a combination of software and hardware where each module and its functionality is executed by separate independent chips connected to each other to function as the system. A person skilled in the art will appreciate that while these method steps describes only a series of steps to accomplish the objectives, these methodologies may be implemented with modifications to the AI system (100) described herein.

It must be understood that the embodiments explained in the above detailed description are only illustrative and do not limit the scope of this invention. Any variation and adaptation to the method to prevent exploitation of AI module (14) in an AI system (100) are envisaged and form a part of this invention. The scope of this invention is limited only by the claims.

1. An artificial intelligence (AI) system for processing of an input, the AI system comprising:
an input interface configured to receive the input from at least one user;
an output interface configured to send an output to the at least one user;
a blocker module configured to block the at least one user;
an information gain module configured to calculate an information gain value and to send the information gain value to the blocker module;
a blocker notification module configured to transmit a notification to an owner of the AI system on detecting an attack vector;
an AI module configured to process input data, the AI module comprising an AI model, the AI model comprising a plurality of processing layers, at least one of the processing layers further comprising one or more parallel processing sub-layers; and
a comparator configured to compare a first set of outputs received from the plurality of processing layers and the parallel processing sub-layers to identify the attack vector from the input, identification information is sent to the information gain module.

2. The AI system for as claimed in claim 1, wherein a differing first set of outputs received from the plurality of processing layers and the parallel processing sub-layers identifies the input as the attack vector.

3. A method to prevent exploitation of an AI module in an AI system, the AI module comprising at least a comparator and a plurality of processing layers, at least one of the processing layers further comprising at least one or more parallel processing sub-layers, the method comprising:
receiving input data from at least one user through an input interface;
transmitting the input data through a blocker module to the AI module;
processing the input data by the plurality of processing layers to generate a first output;
processing the input data by the plurality of processing layers and the parallel processing sub-layers to generate a first set of outputs;
comparing the generated first set of outputs by the comparator to identify an attack vector from the input data, identification information of the attack vector is sent to an information gain module; and
sending an output using the output interface to prevent capturing of the AI module.

4. The method as claimed in claim 3, wherein a differing first set of outputs received from the plurality of processing layers and the parallel processing sub-layers identifies the input as the attack vector.

5. The method as claimed in claim 3, wherein the comparator sends the first output as the output to the output interface, when the attack vector is not identified.

6. The method as claimed in claim 3, wherein the comparator modifies the first output to send the output to the output interface, when the attack vector is identified.

7. The method as claimed in claim 3, wherein the at least one user is blocked by a blocker module based on information received from the information gain module.
